(19) United States
(12) Patent Application Publication
(10) Pub. No.: US 2011/0127226 A1
(43) Pub. Date: Jun. 2, 2011

(54) INFANT FORMULA MERCHANDISER

(75) Inventors: James J. Rataiczak, III, Chesterland, OH (US); Gregory M. Bird, Solon, OH (US); Michael Robert Verdile, Strongsville, OH (US)

(73) Assignee: Fasteners For Retail, Inc.

(21) Appl. No.: 13/023,940

(22) Filed: Feb. 9, 2011

Related U.S. Application Data
(63) Continuation-in-part of application No. 12/008,812, filed on Jan. 14, 2008.
(60) Provisional application No. 60/880,853, filed on Jan. 16, 2007.
(60) Provisional application No. 60/997,789, filed on Oct. 5, 2007.

(51) Int. Cl. A47F 1/04; B65G 59/00; E05B 73/00

(52) U.S. Cl. 211/4; 221/279; 221/221; 70/58

(57) ABSTRACT

A merchandise dispensing apparatus providing theft deterrence includes a product support defining a pathway for supporting a plurality of products in at least one column, and a dispenser mounted to an accessible portion of the product support for selectively presenting an associated lead product in the at least one column for removal from the product support. The dispenser is moveable between a first position blocking access to the product support, and a second position permitting access to the associated lead product in the at least one column while restricting access to any remaining associated products in the at least one column. The dispenser, when moved from the first position to the second position, is configured to move the associated lead product in a direction away from the product support.

### BACKGROUND

The present disclosure pertains to merchandise dispensing devices for retail venues where theft of merchandise which is displayed on open shelves is a concern. More particularly, the present disclosure relates to a dispensing device which allows single products to be accessed but prevents multiple products from being removed from the dispensing device at the same time.

Recently, retail stores which traditionally display products on open shelves have experienced product theft. In self service retail establishments such as drug stores and grocery stores, the merchandise is generally accessible only from the front. However, shelves previously employed have permitted free access to the space above the merchandise held on each shelf. As a result, a person who wishes to do so could quickly and easily remove a large number of articles at one time. It is known for thieves to “sweep” a shelf with their arm collecting the items into a purse, bag or coat very quickly and exit a store, without drawing attention to themselves. This is particularly a problem with high value goods. Items which are in high demand by thieves include cough and cold medications, razor blades, camera, film, batteries, DVDs, smoking and smoking cessation articles, fragrances, infant formula and the like. Shelf sweeping is a particular problem for small items. A thief could steel as much as several hundred dollars worth of merchandise with very little effort and without great risk of being detected. Shelf sweeping relies on the person's ability to remove multiple items from the shelf at the same time.

In order to deter such sweeping, a merchant could only display a single item on the shelf. However, then the merchant or retailer would need to constantly restock the shelf, which would be very difficult to do. Therefore, merchants prefer to keep substantial inventory on a shelf, rendering such inventory susceptible of theft.

Retailers are constantly challenged to balance the needs of legitimate consumers' access to high theft items with measures to minimize the incidence of theft. Because theft has become so rampant in connection with certain product categories such as razors and infant formula, many retail stores are taking such products off the shelf and placing them behind a counter or under lock and key. If this is done, customers must request the products in order to make a purchase. However, such measures are disadvantageous as they add additional labor costs in order to provide individual service to customers who would not normally require it. Also, such a merchandising technique makes it difficult for customers to compare products side by side. Moreover, it may be difficult to store multiple such products behind a counter, as counter space is limited and may be needed for other items, such as prescription medications, expensive fragrances or the like.

There have been some attempts at minimizing such shoplifting losses by the expedient of partially blocking access to display shelves to prevent a mass removal of articles from the shelves but, nevertheless, permitting removal of individual articles by a shopper. One attempt to minimize pilferage of merchandise was by installing a transparent panel in front of each stocked shelf in order to block access to all but a few of the articles on the shelf. However, if the panel is securely fixed in place on the rack or shelf, the panel also prevents or impedes restocking of the shelves. Considering the value of a clerk's time, such a security system may cost more in terms of personnel time than the money it saves in reducing theft. On the other hand, if the panel were to be easily removed or readily moved out of the way, that is, if the manipulation needed for moving the panel out of the way are readily apparent from inspection, then the panel has little value as a security device.

Product dispensing devices which deter theft, such as vending machines, are well known. They have been used for storing products of all sorts and for vending such products to consumers in exchange for money, generally coins and/or currency without vendor attention. However, the known vending machines are expensive to manufacture and operate and are not readily adapted for use in vending numerous types of products in a retail environment such as a drug store or a grocery store.

One attempt to solve the theft problem has been the use of dispensing display cabinets which can be stocked through a lockable door at the rear of the cabinet. Such an arrangement, however, is unsuitable for the shelving commonly used in retail establishments. It is similarly unsuitable for peg board displays also used in retail establishments. Another attempt, as shown in U.S. Pat. No. 4,807,779, employs a transparent front wall which leaves the bottom row of product exposed, together with a sliding door which has a pair of spaced access openings, each affording access to one row of product. This design dictates that a separate size of display unit be manufactured for each size of goods meant to be displayed. Also, for every type of merchandise having another shape or configuration, a different size or shape of door and/or opening would be necessary.

Another design employs a hood or cover which can be mounted above a column of product so as to impede a thief's ability to grab more than one product at a time from a column of such products. Such a design is illustrated in U.S. Pat. No. 5,665,304. However, with this design, a separate such member is necessary for each column of product on each shelf. Moreover, the member is only engageable with a particular type of display unit, in this case, one mounted on a rectangular bar.

Still another design employs a pair of retaining walls, wherein a first retaining wall is shorter in height than is a second retaining wall. This design is illustrated in U.S. Patent Publication No. 2005/0161420. It is said to result in limiting access to product and inhibiting the removal of numerous products at one time. As with the previous design, however, this design necessitates the use of separate second barriers for each column of products and the second barriers may impede access to products more than customers are willing to put up with.

It would be advantageous, therefore, to provide a device or dispensing apparatus which minimizes the incidence of product theft, but allows purchasers access to products without requiring store personnel intervention and which is less expensive than the known vending machines. It would also be advantageous to provide a merchandising apparatus which is able to fit within common grocery, drug store or other retail environment shelves and which effectively displays the products so consumers can easily identify them. It would also be advantageous to provide a dispensing system which is easy to use but provides security. Moreover, it would be advantageous to provide a dispensing device with an interlock for blocking stored merchandise when a dispensed item is made accessible to a consumer.

Accordingly, it has been considered desirable to develop an improved loss prevention merchandiser which would overcome the foregoing difficulties and others while meeting at least some of he above stated needs and providing better and more advantageous overall results.

### BRIEF SUMMARY OF THE DISCLOSURE

A merchandise dispensing apparatus according to the present disclosure provides theft deterrence. More particularly, a merchandise dispensing apparatus for providing theft deterrence comprises a product support defining a pathway for supporting a plurality of products in at least one column, and a dispenser mounted to an accessible portion of the product support for selectively presenting an associated lead product in the at least one column for removal from the product support. The dispenser is moveable between a first position blocking access to the product support, and a second position permitting access to the associated lead product in the at least one column while restricting access to any remaining associated products in the at least column. The dispenser, when moved from the first position to the second position, is configured to move the associated lead product in a direction away from the product support.

The dispenser can include a pivotable retainer wall adapted to pivot between a first orientation generally parallel to a top surface of the product support when the dispenser is in the first position, to a second orientation blocking the pathway and at least partially restricting access to other associated products in the column when the dispenser is in the second position. The dispenser can include a front wall and at least one sidewall, the dispenser being mounted to the product support for pivotal movement between the first and second positions such that the front wall tilts away from the product support. A bottom wall of the dispenser can support a bottom surface of an associated lead product in the column such that the dispenser rotates away from the product support when moved from the first position to the second position thereby changing an orientation of the associated lead product. The front wall of the dispenser can include a transparent section through which the leading product can be viewed. The dispenser can be biased towards the first position and can include a handle portion for enabling a user to move the dispenser from the first position to the second position.

The apparatus can further comprise a movable tile supported for sliding movement by a track oriented generally perpendicular to the product support, the moveable tile selectively movable to a position in front of the dispenser to block movement of the dispenser from the first position to the second position. The apparatus can further include a second dispenser mounted to the product support, the moveable tile being selectively moveable to block an associated lead product from being removed via one or the other of the dispensers. The product support can further include a product support surface, a pair of spaced apart side walls extending from the product support surface, a top wall, and an end wall together defining an enclosure.

In accordance with another aspect of the present disclosure, a merchandise dispensing system for providing theft deterrence comprises a product support defining a pathway for supporting a plurality of products in a plurality of columns and a plurality of dispensers. The dispensers, numbering n, are disposed such that one is mounted to a leading portion of the product support adjacent each column for selectively presenting an associated lead product of each respective column for removal from the product support. A plurality of movable tiles, numbering n-1, are supported for sliding movement by a track extending adjacent to the dispensers. The track is operatively connected to the product support. Each dispenser is movable between a first position blocking access to the product support and a second position permitting access to the lead product in the respective column. Each dispenser, when moved from the first position to the second position, is configured to move the associated lead product in a direction away from the product support. The plurality of movable tiles is selectively moveable to a position such that no tile is located in front of a selected one of the plurality of dispensers to retard withdrawal of the associated lead product from the selected one of the plurality of dispensers.

In accordance with a further aspect of the present disclosure, provided is a merchandising security system. The security system comprises a merchandising structure including a housing defining a product support surface and a support member spaced away from the product support surface. At least one dispenser is mounted to the housing adjacent the product support surface. The at least one dispenser is located adjacent a front end of a column of associated products held on the product support surface and meant to be vended. At least one tile is mounted to the support member. The at least one tile moves laterally in relation to the at least one dispenser to unblock the at least one dispenser.

Other features and advantages of the present disclosure will become apparent from the following more detailed description, taken in conjunction with the accompanying drawings which illustrate by way of example several embodiments of the presently described apparatus and its method of use.

### BRIEF DESCRIPTION OF THE DRAWINGS

The disclosure may take form in certain structures and components, several embodiments of which will be described in detail in this specification and illustrated in the accompanying drawings, in which:

FIG. 1 is a perspective view of a merchandise dispensing apparatus according to an exemplary embodiment of the present disclosure having a pair of dispensers in respective first and second positions;

FIG. 2 is a side elevational view of the merchandise dispensing apparatus of FIG. 1 illustrating the dispenser in the second position;

FIG. 3 is a perspective view of the merchandise dispensing apparatus of FIGS. 1 and 2 from the upper left illustrating a dispenser in a dispensing position;

FIG. 4 is a partial exploded perspective view of the merchandise dispensing apparatus of FIG. 2 illustrating some of the components of the apparatus;

FIG. 5 is a side elevational view in cross section of the apparatus of FIGS. 1 and 2 illustrating a dispenser in a first position;

FIG. 6 is a side elevational view of a dispenser of the merchandise apparatus in a second position;

FIG. 7 is a perspective view of another embodiment of the merchandise dispensing apparatus according to the present disclosure.

### DETAILED DESCRIPTION

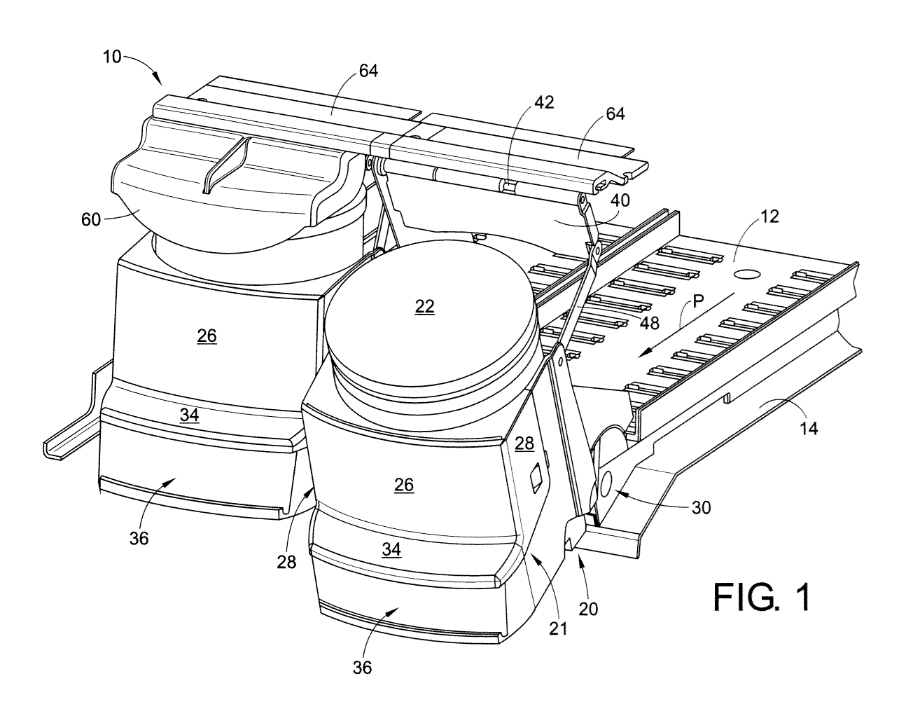

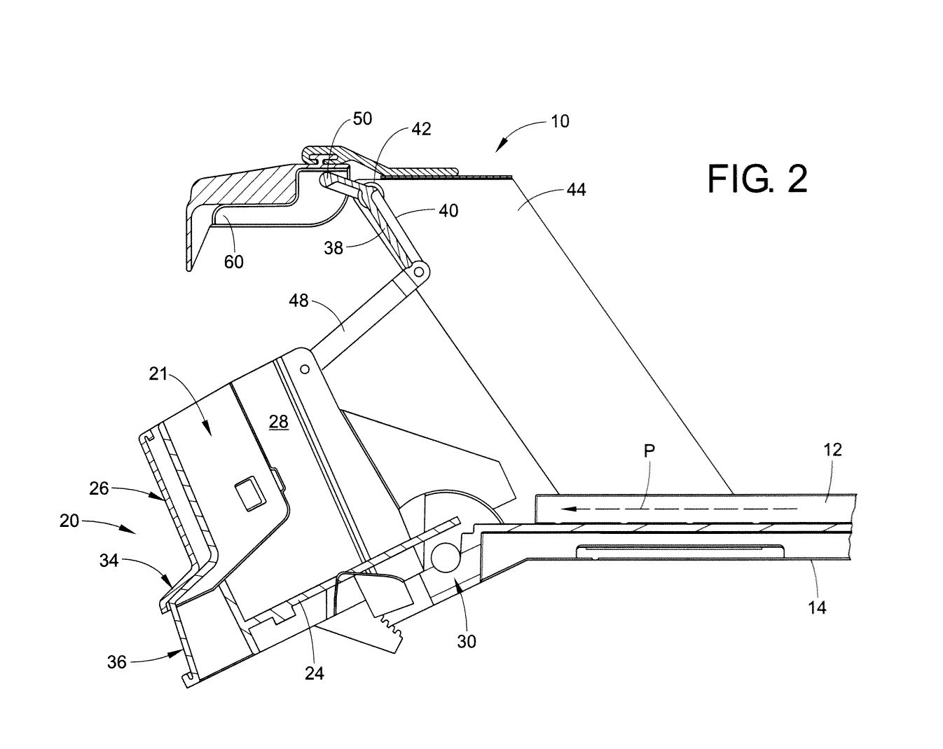

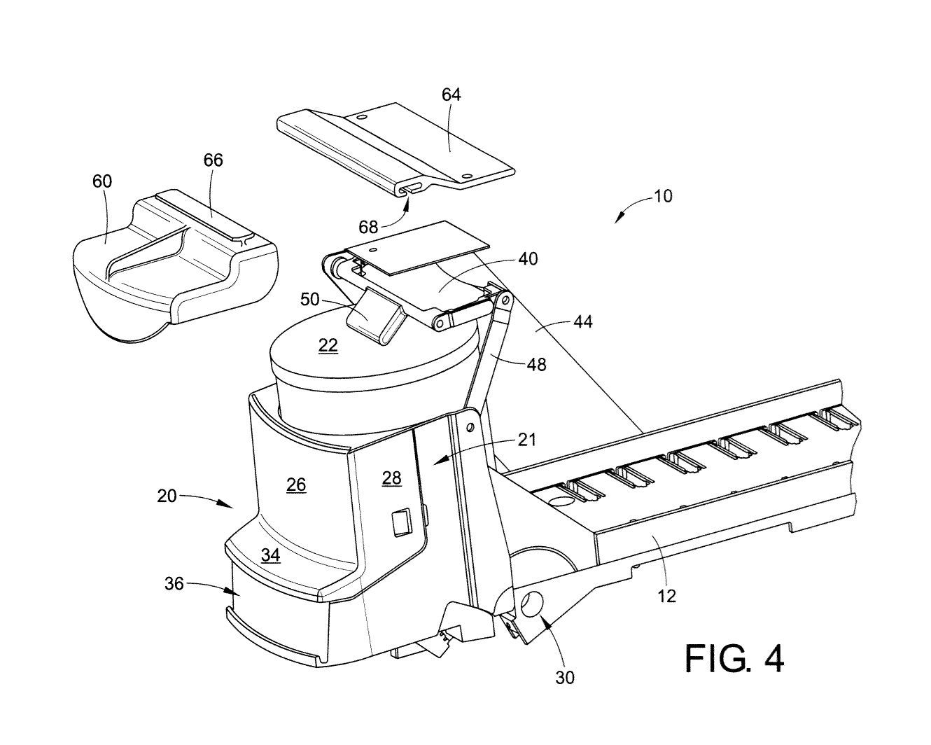

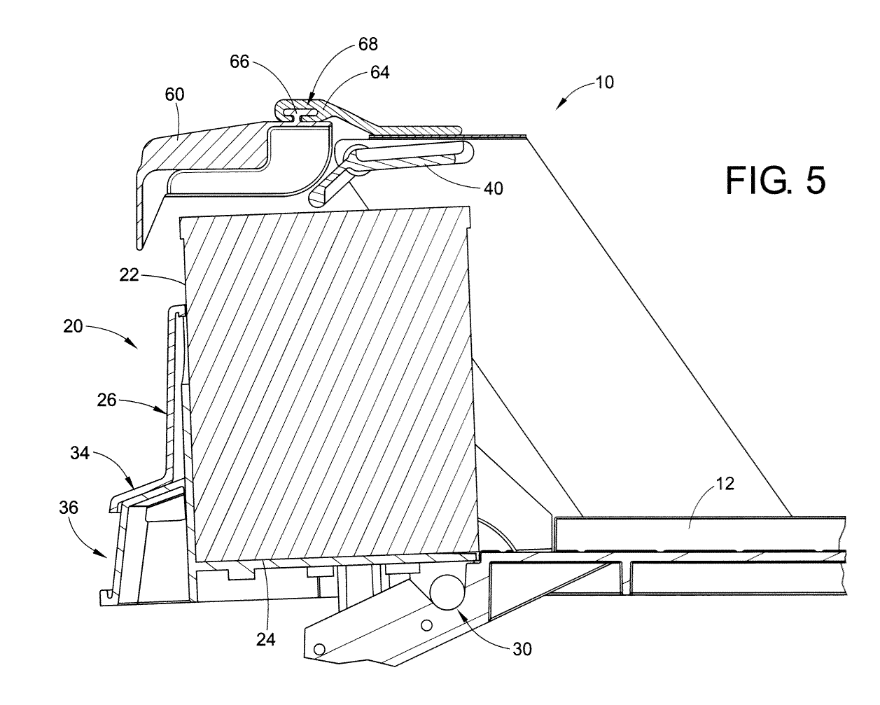

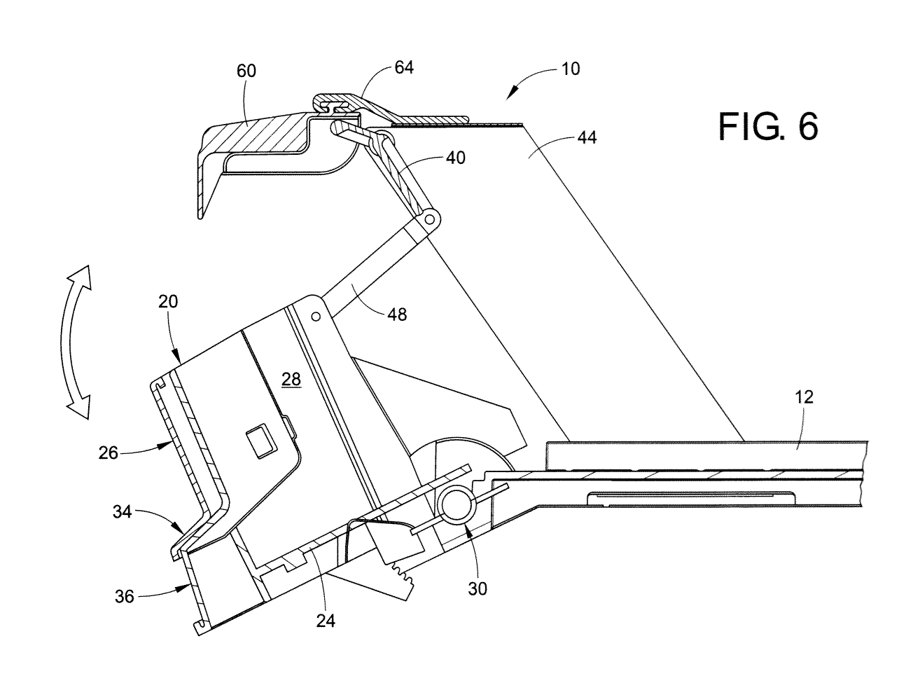

Turning to FIGS. 1-6, and initially to FIGS. 1 and 2, a merchandise dispensing apparatus for providing theft deterrence in accordance with the present disclosure is illustrated and generally identified by reference numeral 10. The apparatus 10 generally includes a product support 12 for supporting a plurality of products in at least one column for movement along a pathway P. The product support 12 in the illustrated embodiment is supported on a shelf 14, such as a shelf commonly found in a retail establishment. In this regard, the product support 12 can be designed with a shape corresponding to a particular type, size and/or brand of commercial shelving. Although not shown, the product support 12 can include one or more interlocking features for securing the product support 12 to the shelf 14.

A dispenser 20 is mounted to a leading portion of the product support 12 for selectively presenting an associated lead product or container of product (such as infant formula) 22 in the at least one column for removal from the product support 12. The dispenser 20 generally includes dispenser body portion 21 having a base 24, a front wall 26 and a pair of sidewalls 28, together generally defining an interior space or pocket in which the leading product container 22 in the column is received. The dispenser can be shaped to accommodate the configuration of the product container. For example, in FIG. 1, a rounded container is illustrated. A portion of one or more of the walls, such as the front wall 26, can be transparent for viewing the lead product container.

The dispenser 20 is mounted to the product support 12 for pivotal movement via a hinge member 30. Accordingly, the dispenser 20 is configured to rotate away from the product support 12 when moved from the first position or orientation to the second position or orientation. In the process of rotating away from the product support 12, the dispenser 20 changes an orientation of the associated lead product 22 (e.g., tilts the product towards the consumer) thereby presenting the product to the consumer for removal from the dispensing apparatus. As will be appreciated, the dispenser 20, when moved from the first position (on the left of FIG. 1) to the second position (on the right), is configured to separate the leading product 22 from any remaining products on the product support 12 by moving the lead product 22 in a direction generally away from the product support 12.

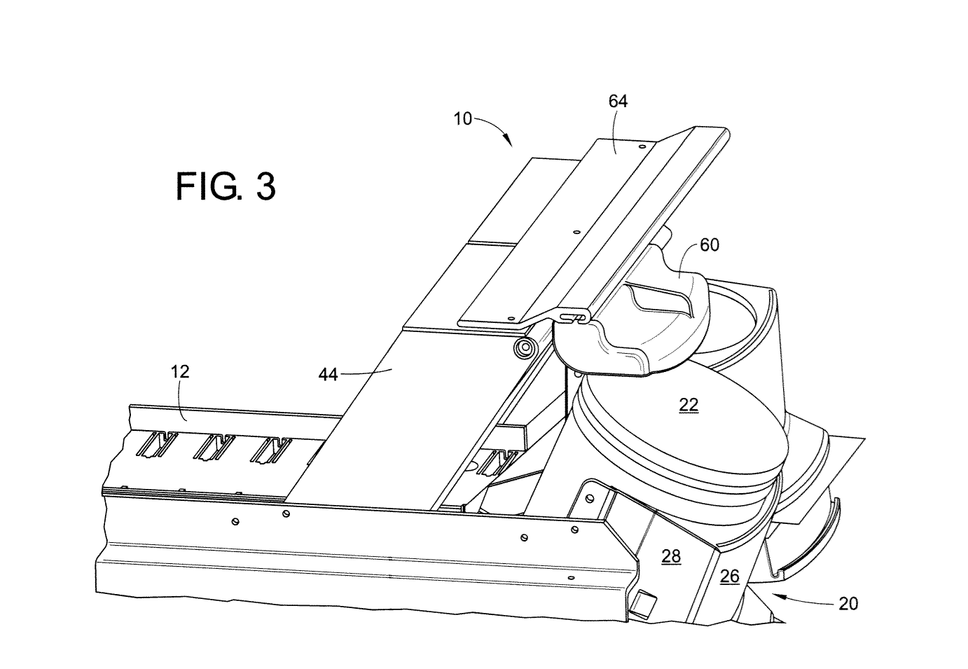

The dispenser 20 in the illustrated embodiment includes a handle 34 in the form of an outwardly extending protrusion, section or surface that a consumer can press in a downward direction in order to move the dispenser body 21 to the second position. A price channel 36 can be provided on the front of the dispenser body 21 for displaying product pricing or other merchandise information. The dispenser 20 can also be biased towards the first position (e.g., the up or closed position) such that in use, after a consumer removes the leading product container 22, the dispenser 20 returns to the first position restricting access to the product support 12. In other words, the dispenser 20 can be biased to the closed portion, such that the bias needs to be overcome in order to pivot the dispenser downwardly and forwardly, as shown in FIG. 1. One or more spring elements, such as spring 38 shown in FIG. 3, can be provided for biasing the dispenser 20 in such manner, as will be appreciated.

The dispenser 20 not only functions to present the leading product container 22 for removal from the dispensing apparatus 10 when in the second position, but also blocks access to other associated product containers in the column other than the associated lead product container 22 (e.g., as shown on the right in FIG. 1). When in the first position (e.g., as shown on the left in FIG. 1), access is restricted to the product support 12 for removal of any products in the column.

To restrict access to any remaining products supported on the product support 12, the dispenser 20 can include a retainer wall 40 that is adapted to move between a position generally parallel to a top surface of the product support 12 when the dispenser 20 is in the first position, to a second position at least partially blocking the pathway P (such as being oriented at an acute angle or right angle in relation to the support top surface) and thereby restricting access to other associated products in the column when the dispenser 20 is in the second position. As will be appreciated, restricting access includes blocking the pathway P such that product containers cannot be removed or cannot be easily removed from the product support, even though the containers may still be visible or even be within grasp of a consumer.

In one embodiment, the retainer wall 40 is pivotally secured via a hinge 42 or the like to an upper support member 44 and is linked to the dispenser body 21 by a pair of linkage bars 48. As will be appreciated from the drawings, movement of the dispenser body 21 from the first position to the second position results in the retainer wall 40 rotating down to block the pathway P. Various size retainer walls can be provided to ensure suitable blocking based on product or container size. For example, if the illustrated system is used in connection with a product having a smaller height dimension than the product 22 shown, a larger retainer wall may be installed to provide additional blocking of the pathway P. The retainer wall 40 can include a downwardly and forwardly extending stop tab 50 that prevents removal of product containers from the dispenser body 21.

To further deter theft, the dispenser system 10 can include a movable tile or blocking member 60 supported for sliding movement by a track 64 that extends in a direction generally perpendicular to the product support 12. To this end, a rail 66 of the movable tile can be received in a corresponding groove 68 in the track. Such track and rail arrangement allows the movable tile 60 to slide transversely relative to the product support 12. The track 64 can be mounted on and supported by the support member 44. It is noted that the tile system protrudes forwardly from the support member 44 so as to overlie a top surface of the product container 22 when the dispenser body 21 is in the first position. The moveable tile 60 is slidable along the track 64 to a position in front of the dispenser body 21 and/or leading product container 22 therein to block or prevent withdrawal of the product container 22 even if the dispenser body 21 has been moved from the first position to the second position. An extension on the tile, such as the stop tab 50 may be provided for this purpose. Thus, in order to remove the leading product container 22, a consumer must first move the tile 60 away from a location in front of the dispenser 20 containing the consumer's desired product.

In the illustrated embodiment of the system 10, two dispensers 20 are positioned on the shelf 14. It should be appreciated, however, that any desired number of dispensers may be arranged side by side and that a merchandising display may have multiple rows of such dispensers arranged one above or below the other. The track 64 is supported by the upper support 44 and extends across the top of each dispenser 20 in a direction parallel with the length of the shelf (e.g., generally perpendicular to the column of products and product support 12). The illustrated system 10, having two dispensers 20, has a single movable tile 60 that can be moved to a position blocking one or the other of the dispensers 20 from being moved to its second position for dispensing. This has the effect of limiting access to a single column of products at any given time and, even then, a consumer will still need to depress the dispenser 20 to remove a product from the accessible column of products. Thus, in some instances, access to a product may require two steps—moving the movable tile from in front of a dispenser containing a desired product, and then depressing the dispenser to its second position.

As will be appreciated, a plurality of paired dispensers as shown can be placed on a given shelf. Alternatively, any desired number of dispensers could be provided along the length of the shelf 14, and a plurality of movable tiles can be mounted in a corresponding track extending across said dispensers. That is, instead of two dispensers, three, four, five, six or more dispensers could be ganged together. In one embodiment, the number of movable tiles of a given gang of dispensers is one less than the number of dispensers in the gang such that at any given time only one column of product containers along the shelf can be accessed.

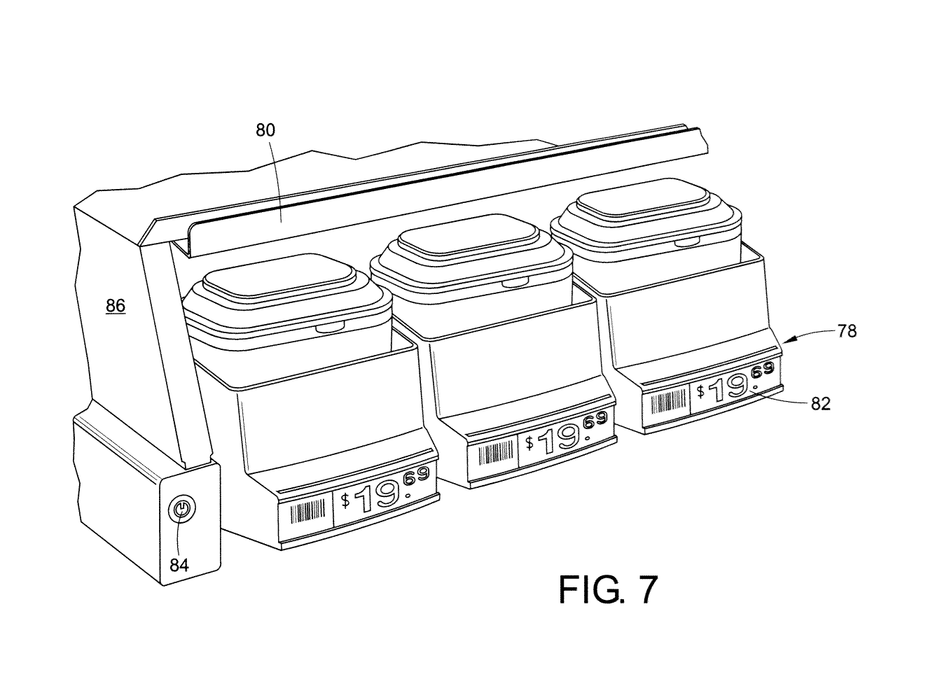

In FIG. 7, a dispensing apparatus 10 in accordance with another embodiment of the disclosure is illustrated as being mounted on a retail shelf assembly. In this embodiment, a product merchandiser 78 for a product container 80 that is generally rectangular or square in shape includes a dispenser 82 which is configured to accommodate such a container. It should be appreciated that a dispenser can be suitably shaped to accommodate a large variety of container shapes and sizes.

If desired, a lock 84 can be provided on a housing 86 of the dispenser system to prevent movement of the dispenser 82. Such a “lock down” option may be advantageous to prevent unauthorized dispensing during times of reduced staffing, evening hours, overnight, or in very high theft areas.

In one embodiment, the product merchandisers 10 and 78 can be gravity fed designs so that the product containers simply slide forwardly when a container in front of them has been removed by a customer. In other embodiments, the design can be pusher fed by a resiliently biased pusher (not shown) as is well known in the merchandising field. In one embodiment, the product merchandisers 10 and 78 can be simply hooked directly to a gondola or support structure (not illustrated) without tools in order to reduce the time and expense of installation.

Disclosed has been a merchandise dispensing apparatus which allows for single dispensing of product but prevents shelf sweeping and deters shoplifting. The disclosed merchandise dispensing apparatus is designed to meet the growing challenge of displaying high theft items in a way that not only protects the merchandise but also makes the merchandise such as containers of a product accessible to potential customers. The product dispensers 20 and 80 allow potential customers to view the labels of the containers or products held in the merchandiser. The dispensers operate on a push lever principle which tilts the product or container forward for dispensing. But, theft deterrence is provided by only dispensing a single product or container at a time and also by making inaccessible other columns of products while one column is being accessed by a potential customer.

The dispensing apparatus disclosed herein could be integrated with an inventory control system (not shown) to monitor the quantity, location and status of product contained in each column of items held in the dispensing apparatus A.

It should be appreciated that the various items and components disclosed herein can be made from any suitable conventional materials which include various types of metals, thermoplastics, reinforced resin materials and combinations thereof.

The exemplary embodiments of the present disclosure have been described with reference to the above detailed description. Obviously, modifications and alterations will occur to others upon a reading and understanding of the preceding detailed description. It is intended that the disclosure not be limited to the embodiments described. Rather, the present disclosure should be construed as including all such modifications and alterations as come within the scope of the appended claims or the equivalents thereof.

1. A merchandise dispensing apparatus for providing theft deterrence, comprising:
a product support defining a pathway for supporting a plurality of products in at least one column; and
a dispenser mounted to an accessible portion of the product support for selectively presenting an associated lead product in the at least one column for removal from the product support;
wherein the dispenser is moveable between a first position blocking access to the associated lead product in the at least one column, and a second position permitting access to the associated lead product while restricting access to any remaining associated products in the at least one column; and
wherein the dispenser, when moved from the first position to the second position, is configured to move the associated lead product in a direction away from the product support.

2. The apparatus of claim 1, wherein the dispenser includes a selectively pivotable retainer wall adapted to pivot between a first orientation generally parallel to a top surface of the product support when the dispenser is in the first position, to a second orientation blocking the pathway and at least partially restricting access to other associated products in the column when the dispenser is in the second position.

3. The apparatus of claim 1, wherein the dispenser includes a front wall and at least one sidewall, the dispenser being mounted to the product support for pivotal movement between the first and second positions such that the front wall tilts away from the product support.

4. The apparatus of claim 1, wherein the dispenser includes a bottom wall for supporting a bottom surface of an associated lead product in the column, and wherein the dispenser rotates away from the product support when moved from the first position to the second position thereby changing an orientation of the associated lead product.

5. The apparatus of claim 1, wherein the front wall of the dispenser includes a transparent section through which the associated lead product can be viewed.

6. The apparatus of claim 1, wherein the dispenser is biased towards the first position.

7. The apparatus of claim 1, wherein the dispenser includes a handle portion for enabling a user to move the dispenser from the first position to the second position.

8. The apparatus of claim 1, further comprising a movable tile supported for sliding movement by a track oriented generally perpendicular to the product support, the moveable tile being selectively movable to a position in front of the dispenser to block movement of the dispenser from the first position to the second position.

9. The apparatus of claim 8, further comprising a second dispenser mounted to the product support, the moveable tile being selectively moveable to block an associated lead product from being removed via one or the other of the dispensers.

10. The apparatus of claim 1, wherein the product support further comprises a product support surface, a pair of spaced apart side walls extending from the product support surface, a top wall, and an end wall together defining an enclosure.

11. A merchandise dispensing system for providing theft deterrence, comprising:
a product support defining a pathway for supporting a plurality of products in a plurality of columns;
a plurality of dispensers, numbering n, one mounted to a leading portion of the product support adjacent each column for selectively presenting an associated lead product of each respective column for removal from the product support; and
a plurality of movable tiles, numbering n-1, supported for sliding movement by a track extending adjacent the dispensers, the track being operatively connected to the product support,
wherein each dispenser s moveable between a first position blocking access to the product support, and a second position permitting access to the lead product in the respective column, each dispenser, when moved from the first position to the second position, being configured to move the associated lead product in a direction away from the product support; and
wherein the plurality of movable tiles is selectively movable to a position such that no tile is located in front of a selected one of the plurality dispensers to retard withdrawal of the associated lead product from the selected one of the plurality of dispensers.

12. A merchandise dispensing system as set forth in claim 11, wherein each dispenser further includes a pivoting retainer wall adapted to pivot between a position generally parallel to a top surface of the product support when the dispenser is in the first position, to a position blocking the pathway and restricting access to other associated products in the column when the dispenser is in the second position.

13. A merchandise dispensing system as set forth in claim 11, wherein at least one of the dispensers includes a front wall and at least one sidewall, the dispenser being mounted to the product support for pivotal movement between the first and second position such that the front wall tilts away from the product support,

14. The apparatus of claim 11, wherein at least one of the dispensers includes a bottom wall for supporting a bottom surface of an associated lead product in the column, and wherein the dispenser rotates away from the product support when moved from the first position to the second position thereby changing an orientation of the associated lead product.

15. The apparatus of claim 11, wherein the front wall of at least one of the dispensers includes a transparent section through which the leading product can be viewed.

16. The apparatus of claim 11, wherein at least one of the dispensers is biased towards the first position.

17. The apparatus of claim 11, wherein at least one of the dispensers includes a handle portion for enabling a user to move the dispenser from the first position to the second position.

18. A merchandising security system comprising:
a merchandising structure including a housing defining a product support surface and a support member spaced away from the product support surface;
at least one dispenser mounted to the housing adjacent the product support surface, wherein the at least one dispenser is located adjacent a front end of a column of associated products held on the product support surface and meant to be vended; and
at least one tile mounted to the support member, wherein the at least one tile moves laterally in relation to the at least one dispenser to unblock the at least one dispenser.

19. The system of claim 18 wherein the at least one dispenser comprises a front wall, at least one side wall and a base wall.

20. The system of claim 18 wherein the at least one dispenser is pivotally mounted to the housing so that the at least one dispenser can move from a first end position preventing withdrawal of the associated products held on the product support surface to a second end position allowing such withdrawal.
